(19) United States
(12) Patent Application Publication
(10) Pub. No.: US 2020/0401745 A1
(43) Pub. Date: Dec. 24, 2020

(54) STRUCTURE ANALYZING METHOD, DEVICE, AND NON-TRANSITORY COMPUTER-READABLE MEDIUM

(71) Applicant: National Central University, Taoyuan City (TW)

(72) Inventors: Tzu-Ying LEE, Taoyuan City (TW); Wen-Hsiao HUNG, Taoyuan City (TW); Kun-Jun CHUNG, Taoyuan City (TW); Hao CHANG, Taoyuan City (TW)

(73) Assignee: National Central University, Taoyuan City (TW)

(21) Appl. No.: 16/687,806

(22) Filed: Nov. 19, 2019

(30) Foreign Application Priority Data
Jun. 19, 2019 (TW) 108121267

(51) Int. Cl. G06F 30/23

(52) U.S. Cl. CPC G06F 30/23; G06F 2111/10

(57) ABSTRACT

The present invention relates to a structure analyzing method, characterized in that a computer is configured to execute a process, including steps of establishing a spatial-temporal discrete governing model for a discontinuous nonlinear structure based on a finite element analysis, in which the spatial-temporal discrete governing model includes an equivalent nodal secant damping coefficient and an equivalent nodal secant stiffness coefficient at current time step; repeatedly calculating until convergence a secant damping coefficient slope and a secant stiffness coefficient slope based on known parameters, the known equivalent nodal secant damping coefficient and the known equivalent nodal secant stiffness coefficient at previous time step through a computer iteration algorithm; and replacing the equivalent nodal secant damping coefficient and the equivalent nodal secant stiffness coefficient by the converged secant damping coefficient slope and the converged secant stiffness coefficient slope acting as initial values for the next time step.

### CROSS-REFERENCE TO RELATED APPLICATION

The present application claims the priority benefit of Taiwan invention patent application serial No. 108121267, dated Jun. 19, 2019, filed in Taiwan intellectual property office. All contents disclosed in the above Taiwan invention patent application is incorporated herein by reference.

### FIELD

The present invention relates to a structure analyzing method and device and a non-transitory computer readable medium, in particular to a structure analyzing method, device and non-transitory computer readable medium using a technique which introduces an approximate process to compute an equivalent nodal secant damping coefficient and an equivalent nodal secant stiffness coefficient used for replacing an inverse matrix computation.

### BACKGROUND

In the prior art, the finite element analysis (FEA), which is also known as the finite element method or the differential method, is a numerical analysis method for solving a series of numerical solutions for a set of differential or integral simultaneous equations based on the variational principle, a.k.a. the variational calculus. It transforms the governing equations for a differential or integral question occurring in a two-dimensional (2D) or a three-dimensional (3D) finite geometry region, into corresponding integral equations, that is algebraic equations. Then the finite geometry region corresponding to the question is divided and discretized into multiple elements consisting of multiple nodes, through which multiple elements are interconnected and form a mesh for and corresponding to the finite geometry region. At last, a collection of the algebraic equations for all elements jointly form a set of simultaneous equations. A numerical approximated solution for the question occurring in the finite geometry region is obtained by computing and solving its corresponding simultaneous equations.

Therefore, the FEA method is currently the most widely used numerical analysis tool no matter in either the academia or industry. It is able to be applied to various and extensive fields, such as, solid mechanics, fluid mechanics, thermodynamics, heat transfer, manufacturing, and structural design. Its most powerful advantage are as follows: it is capable of easily defining and managing all kinds of irregular and complex geometric shapes, and during computing process various load conditions and boundary conditions are easily assigned and given. In particular, it can easily adjust the density of mesh within a certain specific part by increasing or decreasing the density of corresponding elements. The density of mesh is increased for an important part to correspondingly improve the order of accuracy of computation for the important part, and on the contrary, the density of mesh is decreased for an ordinary part to correspondingly cut down overall computing burdens.

However, during the implementation of the FEA method, an inevitable and necessary step is to compute and solve an inverse matrix which step takes, demands and consumes lots of and most computational resources, is a major and significant disadvantage for the FEA method. For instance, when a conventional FEA is applied to analyze and simulate a large complex dynamic structures in the reality world, it must at least construct three types of matrixes including mass matrixes, damping matrixes, and stiffness matrixes, wherein the stiffness matrix in itself is a large and complex matrix and usually hardly simplified into a bandwidth matrix or a diagonal matrix, and then compute the inverse matrix of the property matrix consisting of the above-mentioned three types of matrixes. The result is a computation to solve the corresponding inverse matrix of the property matrix is a very time consuming process that takes, demands and consumes lots of and most computational resources.

Moreover, the computation for the inverse property matrix is not convergence guarantee process, and highly possible to have a divergence result in the end. All of the above mentioned disadvantages cause the inefficiency and low quality for the FEA method applied to solve, compute, analyze or simulate a time-variant nonlinear system, not to mention to simulate the failure mechanisms and collapse of structures which is highly nonlinear and discontinuous.

Since employing conventional implicit dynamic finite element (FE) analysis to simulate the failure mechanisms and collapse of structures is challenging, research on structural collapse frequently adopts explicit dynamic FE analysis, using software such as the LS-DYNA, ABAQUS-Explicit, and OpenSees. In addition to the FE method, the distinct element method and applied element method have demonstrated advantages in simulating the discontinuous behavior among members during collapse. In particular, the distinct element method in conjunction with the explicit central difference integration scheme (CDIS) has been frequently employed to analyze the discontinuous behaviors of granular materials, such as soil and rock, due to its computational efficiency. However, explicit integration methods are conditionally stable. When analyzing a large complicated system with a high-frequency response, very small time steps are required to ensure numerical stability and obtain an accurate solution because iterations are not conducted to rigorously satisfy the equilibrium equations within explicit integrations.

Additionally, damping is inherent in a dynamic system. Once stiffness-proportional damping is taken into account to simulate more realistic structural behavior, the equation decoupling and computational efficiency of explicit CDIS are lost. Furthermore, since CDIS is a multi-step integration method, strictly speaking, it cannot be employed to simulate discontinuous responses. Generally, a typical bridge consists of superstructures, substructures, and appurtenances, and compared to a building, usually includes more types of components with various mechanical properties. In order to realistically simulate the collapse process of bridges, the requirements of the detailed numerical model are very high, which makes numerical procedures complicated and time-consuming. Consequently, a simple, robust, and efficient dynamic analysis method is needed to simulate structures, especially large-scale complicated structures, with highly nonlinear and discontinuous responses under extreme earthquakes.

Furthermore, in recent years, performance-based design has gradually been incorporated into bridge seismic design. Performance objectives are statements regarding the status of structures, such as “fully operational”, “operational”, “life safe”, and “near collapse”, all of which are associated with earthquake hazard levels. However, there are still many challenges that must be overcome before performance-based design is widely accepted.

One of the challenges is to estimate whether a designed structure is capable of achieving the prescribed performance objective of “avoid collapse” under very rare earthquakes. A bridge may undergo progressive failure, including material yielding and cracking, member damage, separation, falling and collision with other members, before the collapse of the entire structure in a catastrophic earthquake. In fact, because of space requirements, facility capacity, and high cost, it is impossible to conduct the shaking table test with a full-scale structure to observe the progressive collapse and identify the failure mechanisms of an entire bridge under seismic excitations. Compounding this dilemma, a reduced-scale experiment is not always accurate due to the difficulty in reproducing a model in detail with analogous mechanical properties.

Hence, there is a need to solve the above deficiencies/issues.

### SUMMARY

In view of various deficiencies and disadvantages in the prior art, based on an implicit structural dynamic finite element analysis (FEA), the present invention provides a concept of adopting an equivalent node secant damping coefficient and an equivalent node secant stiffness coefficient in a discrete governing equation, so that a structure stiffness matrix (K matrix) and a stiffness-proportional damping matrix are diagonalized, identical to no need to establish the structure stiffness matrix and the damping matrix. The present invention uses a lumped mass mode to build a mass matrix, making the equation of motion uncoupled, and only the nodal internal force and damping force of an element are required to calculate. The present invention further adopts any implicit direct integration method together with the increment-iteration procedure to achieve convergence for each step. When the unconditional and implicit direct integration method is adopted, a larger time step can be taken to greatly improve the calculation efficiency.

Because of the use of iterative calculation, the computational efficiency of the present invention is much higher than that of the explicit central difference method when the same precision of solution is desired. Through numerical verification, the convergence rate of the present invention is equivalent to that of the iterative procedure of the traditional quasi-Newton method. The stability and accuracy of the numerical solution are equivalent to those of the traditional implicit direct integration method. Since it is not necessary to establish a structural stiffness matrix and a damping matrix, and only the internal force and the damping force of the element need to be established, any form of finite element and damping element can be directly added to the analysis program. Therefore, the invention can be widely used for analyzing various nonlinear and discontinuous problems.

The present invention provides a structure analyzing method, characterized in that a computer is configured to execute a process including steps of establishing a spatial-temporal discrete governing model for a discontinuous nonlinear structure based on a finite element analysis, in which the model includes an equivalent nodal secant damping coefficient and an equivalent nodal secant stiffness coefficient at a current time step; repeatedly calculating until convergence a secant damping coefficient slope and a secant stiffness coefficient slope based on known parameters, the known equivalent nodal secant damping coefficient and the known equivalent nodal secant stiffness coefficient at a previous time step through a computer iteration algorithm; and replacing the equivalent nodal secant damping coefficient and the equivalent nodal secant stiffness coefficient by the converged secant damping coefficient slope and the converged secant stiffness coefficient slope acting as initial values for a next time step.

Preferably, the discontinuous nonlinear structure is a discontinuous yielded structure, a discontinuous collapsed structure, a discontinuous cracked structure, a discontinuous damaged structure, a discontinuous fallen structure, a discontinuous failed structure, or a discontinuous separated structure.

Preferably, the computer iteration algorithm is a quasi-Newton iteration method, or a secant method.

The present invention further provides a structure analyzing device, characterized in that a hardware processor is configured to implement a process including steps of establishing a spatial-temporal discrete governing model for a discontinuous nonlinear structure based on a finite element analysis, in which the model includes an equivalent nodal secant damping coefficient and an equivalent nodal secant stiffness coefficient at a current time step; repeatedly calculating until convergence a secant damping coefficient slope and a secant stiffness coefficient slope based on known parameters, the known equivalent nodal secant damping coefficient and the known equivalent nodal secant stiffness coefficient at a previous time step through a computer iteration algorithm; and replacing the equivalent nodal secant damping coefficient and the equivalent nodal secant stiffness coefficient by the converged secant damping coefficient slope and the converged secant stiffness coefficient slope acting as initial values for a next time step.

The present invention further provides a non-transitory computer-readable medium storing a program causing a computer to execute a process including of establishing a spatial-temporal discrete governing model for a discontinuous nonlinear structure based on a finite element analysis, in which the model includes an equivalent nodal secant damping coefficient and an equivalent nodal secant stiffness coefficient at a current time step; repeatedly calculating until convergence a secant damping coefficient slope and a secant stiffness coefficient slope based on known parameters, the known equivalent nodal secant damping coefficient and the known equivalent nodal secant stiffness coefficient at a previous time step through a computer iteration algorithm; and replacing the equivalent nodal secant damping coefficient and the equivalent nodal secant stiffness coefficient by the converged secant damping coefficient slope and the converged secant stiffness coefficient slope acting as initial values for a next time step.

Preferably, the above mentioned process further includes steps of discretizing the discontinuous nonlinear structure into a plurality of spatial elements and establishing the spatial-temporal discrete governing model for each of the plurality of spatial elements; applying an equivalent Rayleigh damping to the spatial-temporal discrete governing model to form a second spatial-temporal discrete governing model; and applying the known equivalent nodal secant damping coefficient and the known equivalent nodal secant stiffness coefficient at the previous time step to form a third spatial-temporal discrete governing model including the equivalent nodal secant damping coefficient and the equivalent nodal secant stiffness coefficient.

### DESCRIPTION OF THE DRAWINGS

A more complete appreciation of the invention and many of the attendant advantages thereof are readily obtained as the same become better understood by reference to the following detailed description when considered in connection with the accompanying drawing, wherein:

FIG. 1 is a schematic diagram of using the known parameters and the quasi-Newton method to iteratively approximate the equivalent node secant damping coefficient;

FIG. 2 is a schematic diagram of using the known parameters and the quasi-Newton method to iteratively approximate the equivalent node secant stiffness coefficient;

FIG. 3 is a diagram illustrating the actual structure for the Matsurube bridge before collapse;

FIG. 4(a) and FIG. 4(b) are diagrams illustrating the actual structural for the cross section of the Matsurube bridge pier;

FIG. 5 is a diagram illustrating a structure of two-dimensional numerical model for the Matsurube bridge in an axial direction and a vertical direction thereof;

FIG. 6(a) is a photograph showing the actual damage state for the Matsurube bridge after the earthquake damage;

FIG. 6(b) is a schematic diagram illustrating the damage state of the Matsurube bridge after the earthquake damage;

FIG. 7(a) to FIG. 7(c) are a series of time-variant history diagrams illustrating the ground acceleration recorded by the WITH25 observation station of the KiK-NET strong earthquake observation network during the collapse of the Matsurube bridge;

FIG. 7(d) to FIG. 7(f) are a series of time-variant history diagrams illustrating the ground displacement after two-time integrating the time-variant history of the ground acceleration recorded by the WITH25 observation station of the KiK-NET strong earthquake observation network during the collapse of the Matsurube bridge;

FIG. 8(a) is a time-variant history diagram illustrating the ground displacement along an axial direction of the bridge under the condition that the lower support bedrock does not slide during the collapse of the Matsurube bridge;

FIG. 8(b) is a time-variant history diagram illustrating the ground displacement along the axial direction of the bridge under the condition that the lower support bedrock slides during the collapse of the Matsurube bridge;

FIG. 9(a) to FIG. 9(h) are a series of simulation diagrams illustrating the Matsurube bridge hit by the Iwate-Miyagi inland earthquake using the analytical method of discontinuous nonlinear structure in accordance with the present invention;

FIG. 10 is a schematic diagram illustrating a structure analyzing device in accordance with the present invention; and

FIG. 11 is a flow chart showing multiple steps of implementing the structure analyzing method in accordance with the present invention.

### DETAILED DESCRIPTION

The present disclosure will be described with respect to particular embodiments and with reference to certain drawings, but the disclosure is not limited thereto but is only limited by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice.

It is to be noticed that the term “including”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device including means A and B” should not be limited to devices consisting only of components A and B.

The disclosure will now be described by a detailed description of several embodiments. It is clear that other embodiments can be configured according to the knowledge of persons skilled in the art without departing from the true technical teaching of the present disclosure, the claimed disclosure being limited only by the terms of the appended claims.

The present invention provides a structural dynamic calculation program based on FEA, which uses the equivalent node secant stiffness coefficient and the equivalent node secant damping coefficient to diagonalize the structural stiffness matrix and the stiffness damping matrix, and uses a lumped mass mode to build a mass matrix such that equation of motion is uncoupled. The present invention further adopts any implicit direct integration method together with the increment-iteration procedure to allow each step to achieve a convergence condition.

For a discontinuous nonlinear structure, when FEA is used for numerical analysis and the governing equation is temporally and spatially discretized, the time-space discrete equation in a time step t+Δt is as follows, but not limited to the following equations:

M^{t+Δt}Ü^{(r)}+C^{t+Δt}\dot{U}^{(r)}+^{t+Δt}K_{T}^{(r-1)}ΔU^{(r)}=^{t+Δt}R−^{t+Δt}F_{S}^{(r-1)}, (1)

The (r) represents the r times iteration, M is the mass matrix, C is the damping matrix, ^{t+Δt}K_{T}^{(r-1)} is the tangent stiffness matrix after the (r−1) times iteration, R is the external force vector, ^{t+Δt}F_{S}^{(r-1)} is the internal force vector of an element node, Ü [symbol] \dot{U} are the acceleration vector and the velocity vector of a node, respectively, and ΔU^{(r)} is the incremental displacement vector of the r times iteration. When the structural damping adopts Rayleigh damping, let C=a₀M+a₁K_{I}, where K_{I} is the initial stiffness of the structure, a₀ and a₁ are constants.

The discrete governing equation of the above governing equation at time t+Δt, r times iteration, and degree of freedom (DOF)i is as follows:

$${M}_{i}^{t + Δ t} {\ddot{U}}_{i}^{( r )} + {a}_{0} {M}_{i}^{t + Δ t} {\dot{U}}_{i}^{( r )} + {}_{ }^{t + Δ t}{( {\tilde{C}}_{sec} )}{}_{i}^{( r )} Δ {\dot{U}}_{i}^{( r )} + {}_{ }^{t + Δ t}{( {\tilde{K}}_{sec} )}{}_{i}^{( r )} Δ {U}_{i}^{( r )} = {}_{ }^{t + Δ t}{R}{}_{i}^{ } - {}_{ }^{t + Δ t}{( {F}_{kD} )}{}_{i}^{( r - 1 )} - {}_{ }^{t + Δ t}{( {F}_{S} )}{}_{i}^{( r - 1 )} ( i = 1 , … , n ) \qquad ( 2 )$$

The Δ\dot{U}ᵢ^{(r)} and ΔUᵢ^{(r)} are the incremental velocity vector and the incremental displacement vector of the r times iteration, respectively ^{t+Δt}(F_{kD})ᵢ^{(r-1)} is the element node damping force vector of the previous iteration considering stiffness damping a₁K_{I}, ^{t+Δt}(F_{kD})ᵢ^{(r-1)} is the element node internal force vector of the previous iteration, ^{t+Δt}(\tilde{C}_{sec})ᵢ^{(r-1)} and ^{t+Δt}(\tilde{K}_{sec})ᵢ^{(r-1)} are the equivalent node secant damping coefficient and the equivalent node secant stiffness coefficient, respectively, which are defined as follows:

^{t+Δt}(\tilde{C}_{sec})ᵢ^{(r-1)}Δ\dot{U}ᵢ^{(r-1)}≡Δ^{t+Δt}(F_{kD})ᵢ^{(r-1)} (3)

^{t+Δt}(\tilde{K}_{sec})ᵢ^{(r-1)}ΔUᵢ^{(r-1)}≡Δ^{t+Δt}(F_{S})ᵢ^{(r-1)} (4)

The Δ^{t+Δt}(F_{kD})ᵢ^{(r-1)} and Δ^{t+Δt}(F_{S})ᵢ^{(r-1)} are the element incremental stiffness-proportional damping force and the node internal force of the previous iteration, respectively.

For Eq. (3) and Eq. (4), since Δ\dot{U}ᵢ^{(r)} and Δ^{t+Δt}(F_{kD})ᵢ^{(r-1)} are unknown at the r times iteration, ^{t+Δt}(\tilde{C}_{sec})ᵢ^{(r)} cannot be directly calculated from Eq. (3). Similarly, since ΔUᵢ^{(r)} and Δ^{t+Δt}(F_{S})ᵢ^{(r-1)} are also unknown at the r times iteration, ^{t+Δt}(\tilde{K}_{sec})ᵢ^{(r)} so cannot be directly calculated from Eq. (4).

However, it is worth noting that the invention provides a quasi-Newton iterative method or a secant method to use the known ^{t+Δt}(\tilde{C}_{sec})ᵢ^{(r)} and ^{t+Δt}(\tilde{K}_{sec})ᵢ^{(r)} at a previous iteration to approximate and replace the unknown ^{t+Δt}(\tilde{C}_{sec})ᵢ^{(r)} and ^{t+Δt}(\tilde{K}_{sec})ᵢ^{(r)} at the r times iteration in the discrete governing equation Eq. (2) in order to obtain approximate discrete governing equation as follows:

$${M}_{i}^{t + Δ t} {\ddot{U}}_{i}^{( r )} + {a}_{0} {M}_{i}^{t + Δ t} {\dot{U}}_{i}^{( r )} + {}_{ }^{t + Δ t}{( {\tilde{C}}_{sec} )}{}_{i}^{( r - 1 )} Δ {\dot{U}}_{i}^{( r )} + {}_{ }^{t + Δ t}{( {\tilde{K}}_{sec} )}{}_{i}^{( r - 1 )} Δ {U}_{i}^{( r )} = {}_{ }^{t + Δ t}{R}{}_{i}^{ } - {}_{ }^{t + Δ t}{( {F}_{kD} )}{}_{i}^{( r - 1 )} - {}_{ }^{t + Δ t}{( {F}_{S} )}{}_{i}^{( r - 1 )} ( i = 1 , … , n ) \qquad ( 5 )$$

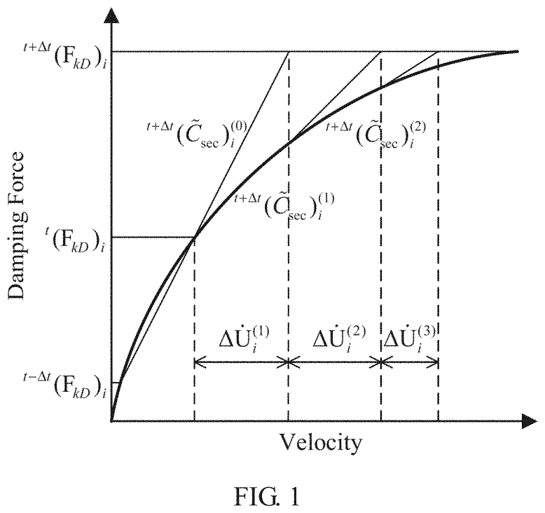

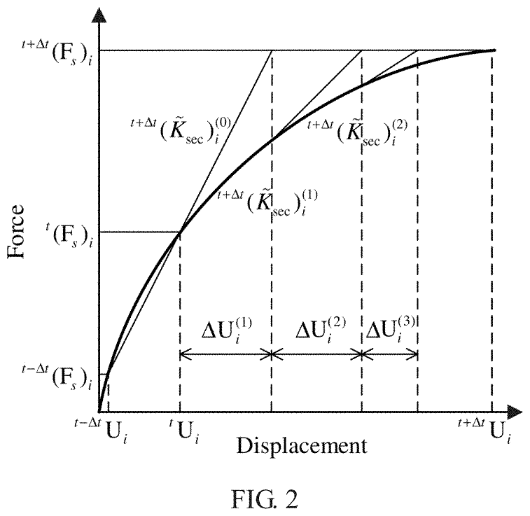

FIG. 1 is a schematic diagram of using the known parameters and the quasi-Newton method to iteratively approximate the equivalent node secant damping coefficient. FIG. 2 is a schematic diagram of using the known parameters and the quasi-Newton method to iteratively approximate the equivalent node secant stiffness coefficient. As shown in Eq. (6) and Eq. (7) and revealed in FIG. 1 and FIG. 2, since the initial conditions of ^{t+Δt}(\tilde{C}_{sec})ᵢ⁽⁰⁾ and ^{t+Δt}(\tilde{K}_{sec})ᵢ⁽⁰⁾ are known, using, for example, quasi-Newton method together with other known conditions can accurately approximate ^{t+Δt}(\tilde{C}_{sec})ᵢ^{(r)} and ^{t+Δt}(\tilde{K}_{sec})ᵢ^{(r)}, respectively, through multiple iterations:

^{t+Δt}(\tilde{C}_{sec})ᵢ⁽⁰⁾(^{t}\dot{U}ᵢ−^{t-Δt}\dot{U}ᵢ)=^{t}(F_{kD})ᵢ−^{t-Δt}(F_{kD})ⁱ (6)

^{t+Δt}(\tilde{K}_{sec})ᵢ⁽⁰⁾(^{t}Uᵢ−^{t-Δt}Uᵢ)=^{t}(F_{S})ᵢ−^{t-Δt}(F_{S})ⁱ (7)

The present invention uses the quasi-Newton method to approximate ^{t+Δt}(\tilde{C}_{sec})ᵢ^{(r)} and ^{t+Δt}(\tilde{K}_{sec})ᵢ^{(r)}, thereby avoiding the use of conventional FEA. In solving Eq. (2), a large inverse matrix must be calculated, resulting in a possible disturbance of computation demanding and divergence. The method provided by the present invention can be solved by any implicit direct integration method. For example, in applying the implicit Newmark integration method, in the case of neither constructing a structural stiffness matrix ^{t+Δt}K_{T}^{(r-1)} and a damping matrix C nor calculating the corresponding inverse matrix, it is only necessary to calculate the node internal force and damping force of the element, and any form of finite element and damping element can be directly added to the analysis program. The method provided by the invention can be widely used to analyze various nonlinear and discontinuous problems, and is particularly suitable for structurally discontinuous problems, such as: calculation and simulation of materials after yield, structural damage and fracture, and structural discontinuities etc.

The method can calculate the stiffness-proportional damping of individual elements, separately calculate the stiffness-proportional damping force of individual elements of different structural parts, and easily solve the problem of difficulties in dealing with the traditional explicit integration method, while maintaining the non-coupling characteristics of the equation of motion. In addition, this calculation program can also be used to develop a variety of different finite elements, such as: special support elements (variable frequency support) and special damping elements (variable stiffness damping) etc. for structural control, which can be quickly and easily added to the calculation program.

The present invention provides the concept of equivalent node secant stiffness and damping coefficients for the calculation program of implicit structural dynamic finite elements to diagonalize the structural stiffness matrix and the stiffness damping matrix, uses a lumped mass mode to build a mass matrix, making the equation of motion uncoupled. The present invention further adopts any implicit direct integration method together with the increment-iteration procedure to allow each step to achieve a convergence condition. When the unconditional and implicit direct integration method is adopted, a larger time step can be taken to greatly improve the calculation efficiency. Because of the use of iterative calculation, the computational efficiency of the present invention is much higher than that of the explicit central difference method when the same precision of solution is desired. Through numerical verification, the convergence rate of the present invention is equivalent to that of the iterative procedure of the traditional quasi-Newton method. The stability and accuracy of the numerical solution are equivalent to those of the traditional implicit direct integration method. Since it is not necessary to establish a structural stiffness matrix and a damping matrix, and only the internal force and the damping force of the element need to be established, any form of finite element and damping element can be directly added to the analysis program, so the invention can be widely used for analyzing various nonlinear and discontinuous problems.

Since it is not necessary to solve the inverse matrix of the property matrix of the simultaneous governing equations, instead use the secant damping coefficient and secant stiffness coefficient to approximate the real solution, the method provided by the present invention is very suitable for the analysis of discontinuous nonlinear structures, for example, simulating or analyzing the behavior of structures beyond the yield point. In the following embodiment, the actual bridge collapse caused by earthquake, i.e. the bridge collapse caused by multiple support vibration (MSE), is taken as an example to illustrate the powerful effectiveness of the analytical method of the invention in the simulation and analysis of discontinuous nonlinear structures.

This embodiment takes a time-variant simulation of the Matsurube bridge (in the city of Ichinoseki, Iwate prefecture, Japan) subjected to earthquake damage as an example. The Matsurube bridge was built in 1987. It crosses the Iwai river and connects Ichinoseki and Akita. In Jun. 14, 2008, it was hit by a 6.9-Mw Iwate-Miyagi inland earthquake at 8:43 local time and collapsed. It reserved a complete record before and after the collapse, which is very suitable for verifying the analysis of the discontinuous nonlinear structure of the present invention.

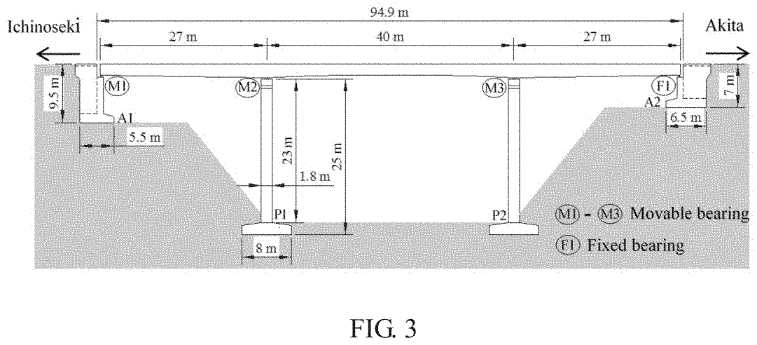

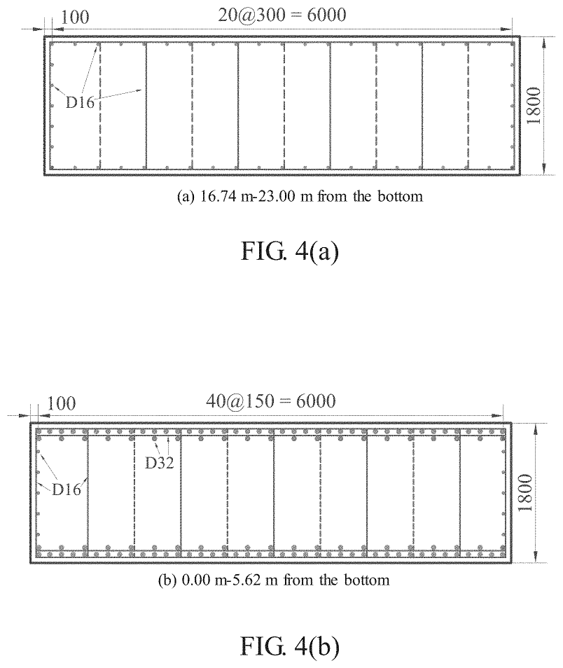

FIG. 3 is a diagram illustrating the actual structure for the Matsurube bridge before collapse. FIG. 4(a) and FIG. 4(b) are diagrams illustrating the actual structural for the cross section of the Matsurube bridge pier. As shown in FIG. 3, the main structure of the Matsurube bridge is a three-span bridge with a total span of 27 meters+40 meters+27 meters=94 meters. The deck D itself is composed of four I-shaped steel beams and reinforced concrete slabs, with a total mass of 980 metric tons. The deck D is supported by two reinforced concrete (RC) piers P1 and P2 and two RC abutments A1 and A2. Each pier is 25 meters high and has a spread foundation. The columns of the piers P1 and P2 are 23 meters long and have an RC section of 6.2 meters by 1.8 meters, as shown in FIG. 4. The RC abutments A1 and A2 disposed at both ends of the deck have an inverted T-shaped foundation. The bridge deck and the abutment A2 are connected by a fixed support F1, and the bridge deck and the piers P1, P2, abutment A1 are connected by movable supports M1-M3. The fixed support does not allow the deck to move, while the movable support allows the deck to move along the axial direction of the bridge deck.

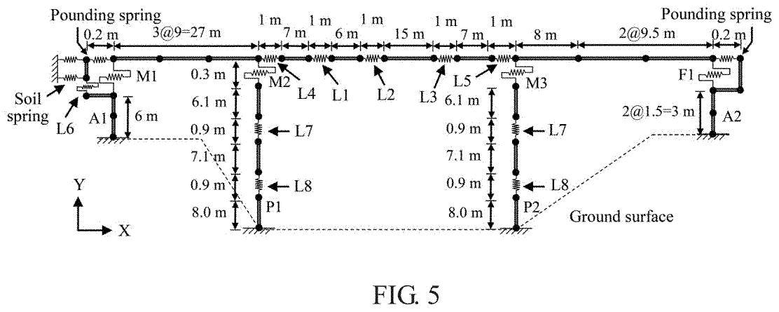

FIG. 5 is a diagram illustrating a structure of two-dimensional numerical model for the Matsurube bridge in an axial direction and a vertical direction thereof. In this embodiment, the structural body analyzing method provided in the invention is applied to the strong earthquake analysis of the bridge structure. Since strong earthquake analysis of a bridge usually needs to deal with the damaged discontinuous structure, conventional FEA is generally unable to solve the strong earthquake problem of the bridge. However, the present invention is particularly suitable for the analysis and simulation of the discontinuous structure. As shown in FIG. 5, various detailed structural components of the Matsurube bridge are simplified into two-dimensional numerical model in space geometry, and the structure of the Matsurube bridge is deconstructed and discretized into an FEA model composed of multiple nonlinear beam elements, column elements, connecting elements, and supporting elements, wherein the beam elements and the column elements are simulated by, for example, but not limited to, an Euler-Bernoulli beam model to establish a discontinuous nonlinear dynamic model. All structural parameters of the Matsurube bridge have corresponding detailed records, as recorded in Table 1 to Table 3, which can be used as various boundary conditions.

Table 1 records various materials and section parameters of the RC column and the I-beam of the Matsurube bridge deck.

TABLE 1
various materials and section parameters
of the RC column and the I-beam

| | | Young's | Sectional | Moment of |
|---|---|---|---|---|
| | Density | modulus | area | inertia |
| | (kg/m³) | (kN/m²) | (m²) | (m⁴) |
| I-beam | 23670 | 2.03 × 10⁸ | 0.45 | 0.3992 |
| RC column | 2400 | 2.13 × 10⁷ | 11.2 | 3.0132 |

Table 2 records the parameters of all connecting elements in FEA.

TABLE 2
parameters of all connecting elements

| | L1/L2/L3 | L4/L5 | L6 | L7 | L8 |
|---|---|---|---|---|---|
| Shear stiffness, | — | — | 3.05 × 10¹² | 7.39 × 10⁸ | 7.39 × 10⁸ |
| kᵥ (kN/m) | | | | | |
| Shear fracture | — | — | 2.14 × 10³ | 3.75 × 10³ | 4.00 × 10³ |
| strength, Vᵤ (kN) | | | | | |
| Initial flexural | 5.66 × 10⁷ | 7.98 × 10⁷ | 1.02 × 10⁹ | 4.99 × 10⁷ | 4.99 × 10⁷ |
| stiffness, | | | | | |
| k_{M} (kN-m/rad) | | | | | |
| Yielding moment, | 2.38 × 10⁴ | 3.43 × 10⁴ | 1.55 × 10³ | 8.26 × 10³ | 2.54 × 10⁴ |
| M_{y} (kN-m) | | | | | |
| Flexural ductility, | — | — | — | 30 | 30 |
| capacity(θᵤ/θ_{y}) | | | | [25] | [25] |

Table 3 lists records of the parameters of all supports of the Matsurube bridge.

TABLE 3
supports parameters

| | M1 | M2 | M3 | F1 |
|---|---|---|---|---|
| Rupture strength (kN) | 1456 | 4860 | 4860 | 1812 |
| Allowable displacement (mm), | 50/60 | 52/58 | 48/62 | 0 |
| (^{L}Δ_{b}/^{R} Δ_{b}) | [55/55] | [55/55] | [55/55] | |

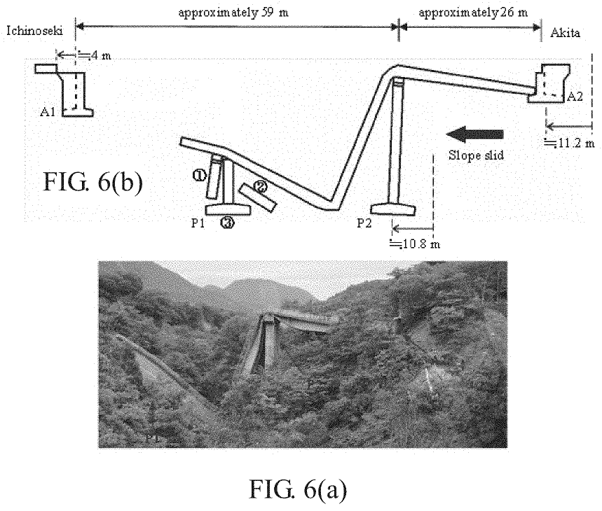

FIG. 6(a) is a photograph showing the actual damage state for the Matsurube bridge after the earthquake damage. FIG. 6(b) is a schematic diagram illustrating the damage state of the Matsurube bridge after the earthquake damage. According to the field investigation after the earthquake, the main cause of the collapse of the Matsurube bridge is the sliding of the supporting bedrock below the bridge. According to the records, the sliding of the rock disk is mainly along the axial direction of the bridge, so the collapse behavior of the bridge can be roughly described by a plane composed of the axial direction and the vertical direction of the bridge. Therefore, the bridge is represented by a two-dimensional numerical model as shown in FIG. 5, and the two-dimensional numerical model shown in FIG. 4(a) and FIG. 4(b) are used to simulate and investigate the collapse behavior of the Matsurube bridge in the earthquake. After the Matsurube bridge was damaged by the Iwate-Miyagi inland earthquake in 2008, the actual on-site collapse state is shown in the photo of FIG. 6(a), and the corresponding schematic diagram of the actual collapse state is shown in FIG. 6(b).

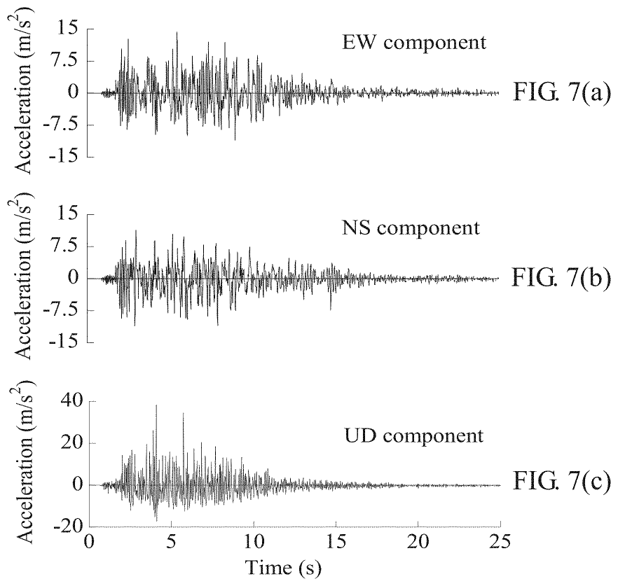

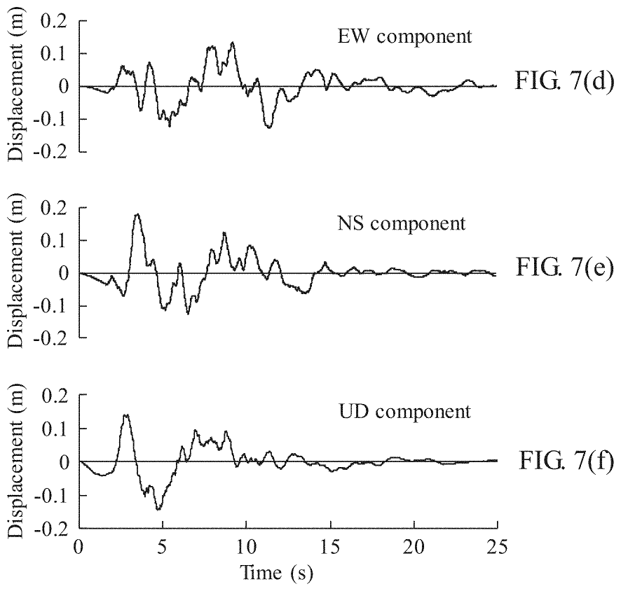

FIG. 7(a) to FIG. 7(c) are a series of time-variant history diagrams illustrating the ground acceleration recorded by the WITH25 observation station of the KiK-NET strong earthquake observation network during the collapse of the Matsurube bridge. FIG. 7(d) to FIG. 7(f) are a series of time-variant history diagrams illustrating the ground displacement after two-time integrating the time-variant history of the ground acceleration recorded by the WITH25 observation station of the KiK-NET strong earthquake observation network during the collapse of the Matsurube bridge. Assuming that the dispersion and incoherence of ground motion are neglected, according to the record of the WITH25 observation station, located about 1.5 km to the southwest of the Matsurube bridge, of the KiK-NET strong earthquake observation network of the national research institute for earth science and disaster resistance, this observation station completely records the time-variant history diagram of the ground acceleration in the EW, NS, and UD directions during the Iwate-Miyagi inland earthquake, as shown in FIG. 7(a) to FIG. 7(c). Roughly, the peak values of ground acceleration in the EW, NS, and UD directions are 14.32 m/s2, 11.43 m/s2, and 38.66 m/s2, respectively.

According to the field investigation results, the cause of the collapse of the abutment A2 and the pier P2 is not only due to strong ground excitation, but also due to the sliding of the supporting bedrock below the bridge. The sliding of the supporting bedrock resulted in permanent displacements of 11.2 meters for the abutment A2 and 10.8 meters for the pier P2, as shown in FIG. 6(b). Therefore, different ground motion conditions must be preset to the abutment A2 and the pier P2. In this embodiment, the equation of motion (EOM) in absolute coordinates is used, and the problem is assumed to be a multiple-support excitation (MSE) problem. The time-variant history diagrams of the ground displacement are shown in FIG. 7(d) to FIG. 7(f).

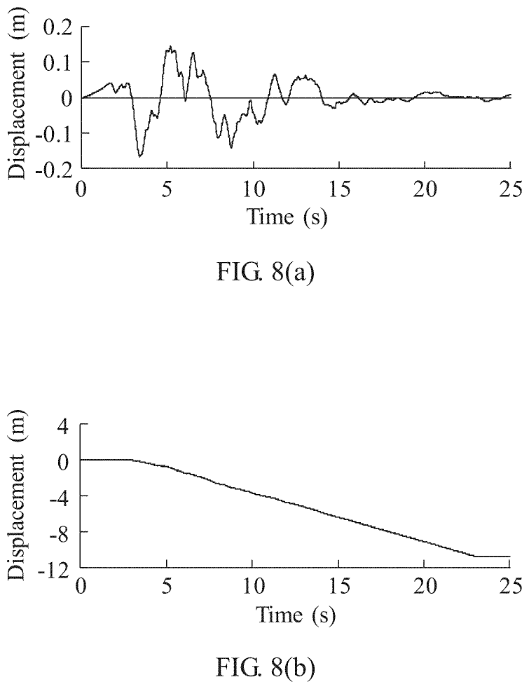

FIG. 8(a) is a time-variant history diagram illustrating the ground displacement along an axial direction of the bridge under the condition that the lower support bedrock does not slide during the collapse of the Matsurube bridge. FIG. 8(b) is a time-variant history diagram illustrating the ground displacement along the axial direction of the bridge under the condition that the lower support bedrock slides during the collapse of the Matsurube bridge. Because the inclination angle of the axial direction of the Matsurube bridge towards the Ichinoseki city from the north is about −133°, the displacement in the axial direction of the Matsurube bridge is calculated using the data in the EW and NS directions. Since the support bedrock below the abutment A1 and the pier P1 of the Matsurube bridge does not slide, the ground displacement time-variant history data disclosed in FIG. 8 (a) are used as an input condition for the ground displacement. However, for abutment A2 and the pier P2, because the lower support bedrock does slide, the ground displacement time-variant history data disclosed in FIG. 8 (b) are used as an input condition for the ground displacement. The data disclosed in FIG. 7(a) to FIG. 7(f) and in FIG. 8(a) to FIG. 8(b) can be used as initial conditions.

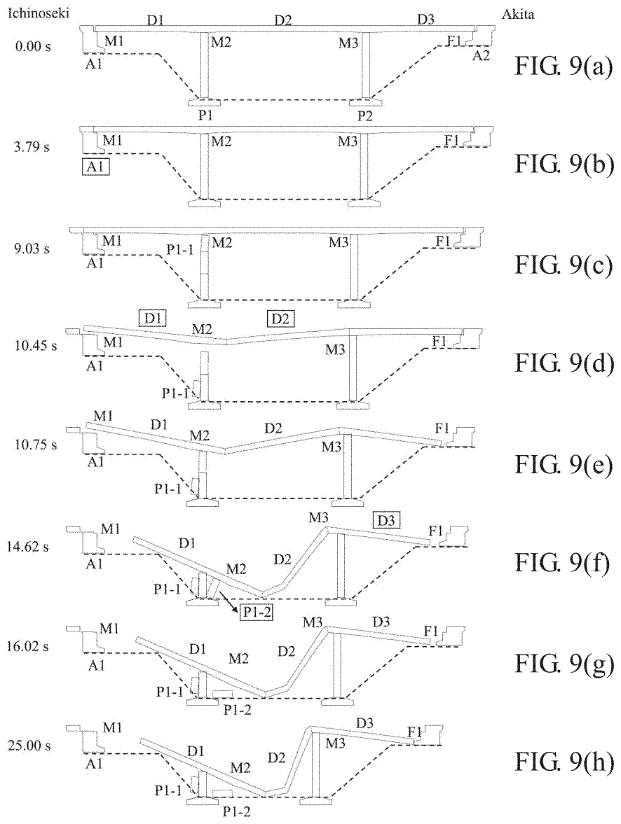

FIG. 9(a) to FIG. 9(h) are a series of simulation diagrams illustrating the Matsurube bridge hit by the Iwate-Miyagi inland earthquake using the analytical method of discontinuous nonlinear structure in accordance with the present invention. After the parameters of FEA are input and set, method for analyzing the discontinuous nonlinear structure of the present invention is implemented to simulate the complete process of the Matsurube bridge hit by the Iwate-Miyagi inland earthquake from an intact structure to the collapse with time. The complete simulation results are shown in FIG. 9(a) to FIG. 9(h).

According to the simulation results, when the earthquake lasts 25 seconds from the beginning, the Matsurube bridge has exhibited a simulation result very close to the collapsed state revealed in FIG. 6(b). The fixed support F1 of abutment A2 began to suffer MSE damage in 2.03 seconds, and the support bedrock began to slide in 3.4 seconds. At this moment, abutment A2 and pier P2 also began to move towards the direction of Ichinoseki city with the support bedrock, and then the deck began to be pushed and hit by the abutment A2, resulting in axial displacement of the bridge and finally hitting the abutment A1. As shown in FIG. 9(b), the upper structure of the abutment A1 began to separate from the body in 3.79 seconds. The upper structure is continuously pushed from an axial direction of the deck, and the deck continues to push the piers P1 and P2. As shown in FIG. 9(c), in 9.03 seconds, pier P1 began to break owing to the push by the deck, and the upper structure of the abutment A1 is also pushed by the deck towards the direction of Ichinoseki city to produce a displacement of about 4 meters. However, because pier P2 moved with the support bedrock, it did not break in 9.03 seconds.

As shown in FIG. 9(d), the upper half of the pier P1 began to fall towards the ground due to the fracture in 10.45 seconds, resulting in an unsupported deck of a total length of about 65 meters, so the deck also began to bend into two sections of decks D1 and D2. Further, decks D1 and D2 also began to fall to the ground, the movable support M1 between the deck D1 and the abutment A1 began to break, and the deck D1 began to separate from the abutment A1. At the same time, the deck D3 also began to be pulled towards the direction of Ichinoseki city to separate from the fixed support F1 of the abutment A2.

As shown in FIG. 9(e), in 10.75 seconds the deck D1 and the deck D2 are temporarily supported by the pier P1 and suspended to fall to the ground. However, the movable support M1 of the abutment A1 and the fixed support F1 of the abutment A2 have been completely damaged by the earthquake. The deck D1 has been completely separated from the movable support M1 of the abutment A1, and the deck D3, after a period of dragging, has fallen to the ground below the abutment A2. As shown in FIG. 9(f) to FIG. 9(g), in time from 14.62 seconds to 16.02 seconds, since the pier P1 has broken into three sections and dropped to the ground, the pier P1 has been no support to the decks D1 and D2. Further, the deck D1 has completely separated from the movable support M1 of the abutment A1, so the deck D1 slides towards the center and downwardly along the slope of the river channel on the side of Ichinoseki city to the center of the river channel and falls into the riverbed. At this time, because the earthquake is still continuing and the ground and the lower bedrock are still moving towards the direction of Ichinoseki city, deck D3, pier P2, abutment A2, bedrock below the abutment A2, etc. are still moving towards the direction of Ichinoseki city and the falling deck D2 is also breaking into several sections.

As shown in FIG. 9(h), the earthquake ended at 25.00 seconds, and destruction to the Matsurube bridge by the earthquake was roughly completed at approximately 14.62 seconds, as revealed in FIG. 9(f). For the time passed from 14.62 seconds and 25.00 seconds in FIG. 9(f) to FIG. 9(h), structural damage to the Matsurube bridge is roughly no difference. According to the simulation results, from about 24.8 seconds no further structural damage to the Matsurube bridge has occurred. FIG. 9(h) shows the simulated damage state of the Matsurube bridge when the earthquake stops, which is very similar to the on-site actual damage state shown in FIG. 6 (a) and the schematic damage state shown in FIG. 6 (b).

The process of the above-mentioned simulation operation for the Matsurube bridge hit by the Iwate-Miyagi inland earthquake in 2008 was highly nonlinear and structurally discontinuous. From an original complete dynamic continuous system of the Matsurube bridge gradually collapsed into several separate and discontinuous structural members during the earthquake, such a highly nonlinear and structurally discontinuous structure cannot be analyzed or simulated with FEA. However, the structure analyzing method and the computer program product provided by the present invention can replace the solution of the inverse matrix of the property matrix by using the secant damping coefficient slope and the secant stiffness coefficient slope, such that the dynamic simulation and analysis of the highly nonlinear and discontinuous structural body can be easily carried out, thus proving the high feasibility of the invention in the analysis of nonlinear and discontinuous structures.

Therefore, the implicit structural dynamic finite element calculation program of the invention can be used to simply handle the above highly nonlinear and discontinuous problems, and has the characteristics of stability, robustness and high efficiency and can be applied to the engineering field. This analyzing method can help in understanding the failure sequence and collapse of the designed structure when it reaches the limit state and verifying whether the designed structure meets the set performance at different seismic levels. It can be applied to check the structural seismic design to verify and confirm whether the designed structure meets the set performance at different seismic levels.

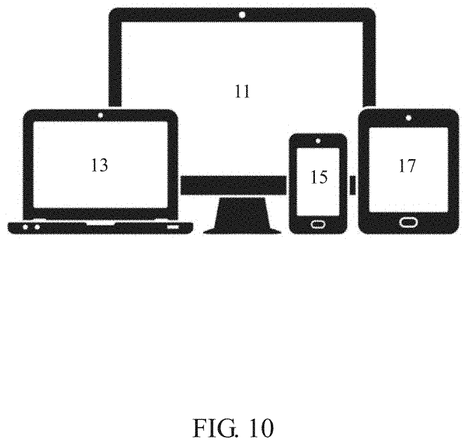

FIG. 10 is a schematic diagram illustrating a structure analyzing device in accordance with the present invention. The method for analyzing a structure provided by the present invention is executed by compiling a computer program product, a mobile device application (App), or a computer software all containing structure analysis logic of the present invention, and loading the programs into a computer via a computer processor. The computer program product, the mobile device application, or the computer software of the present invention refers to a program that can be read by a computer and is not limited to an external form. When any computer device is loaded with the computer program product of the present invention, it becomes the structure analyzing device of the present invention. For example, as shown in FIG. 10, when a desktop computer 11, a notebook computer 13, a smart phone 15, a tablet device 17, or any mobile device in FIG. 10 is loaded with the computer readable program product including the structure analyzing method of the present invention, the device becomes the structure analysis device provided by the present invention.

The structure analysis device of the present invention is preferably any computing device. When the processor of any computing device is loaded with a computer readable program product including the structure analyzing method of the present invention, the computing device then becomes the structural analysis device provided by the present invention. The computing device may be a specific purpose device, and is specially made for executing the structure analyzing method of the present invention. The computing device may or may not have an input element, and the computing device may or may not have an output interface.

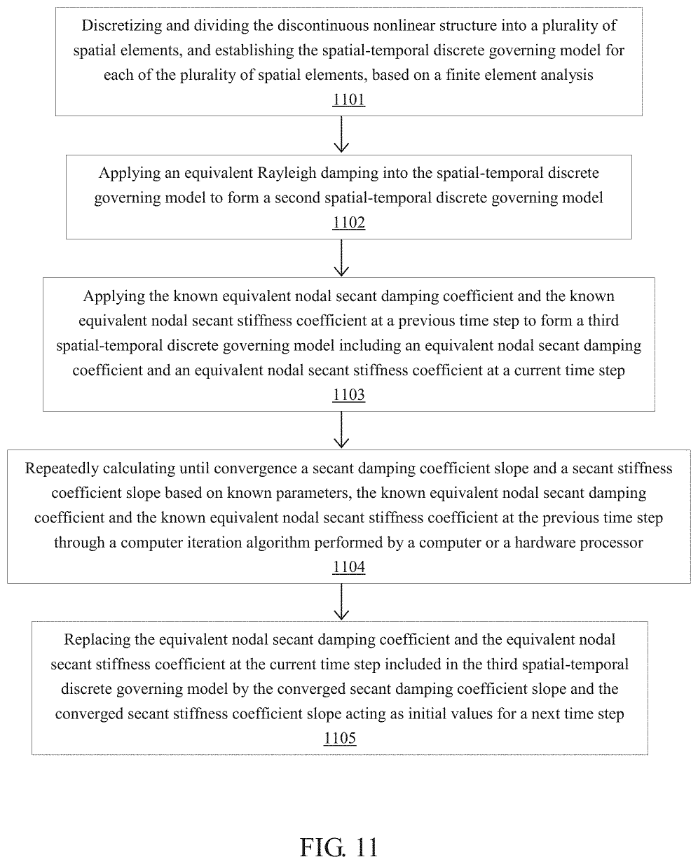

FIG. 11 is a flow chart showing multiple steps of implementing the structure analyzing method in accordance with the present invention. In summary, the structure analyzing method of the present invention includes the following steps: step 1101: discretizing and dividing the discontinuous nonlinear structure into a plurality of spatial elements, and establishing the spatial-temporal discrete governing model for each of the plurality of spatial elements, based on a finite element analysis; step 1102: applying an equivalent Rayleigh damping into the spatial-temporal discrete governing model to form a second spatial-temporal discrete governing model; and step 1103: applying the known equivalent nodal secant damping coefficient and the known equivalent nodal secant stiffness coefficient at a previous time step to form a third spatial-temporal discrete governing model including an equivalent nodal secant damping coefficient and an equivalent nodal secant stiffness coefficient at a current time step.

Step 1104: repeatedly calculating until convergence a secant damping coefficient slope and a secant stiffness coefficient slope based on known parameters, the known equivalent nodal secant damping coefficient and the known equivalent nodal secant stiffness coefficient at the previous time step through a computer iteration algorithm performed by a computer or a hardware processor; and step 1105: Replacing the equivalent nodal secant damping coefficient and the equivalent nodal secant stiffness coefficient at the current time step included in the third spatial-temporal discrete governing model by the converged secant damping coefficient slope and the converged secant stiffness coefficient slope acting as initial values for a next time step.

In summary, this finite element dynamic analysis program combines the advantages of traditional explicit and implicit direct integration methods, and has no disadvantages. Further, structural stiffness-proportional damping can be considered in the structural model, which is especially suitable for analyzing highly nonlinear and discontinuous large-scale structural dynamic systems with robust properties and high efficiency. In the historical earthquake disasters, cases of structure collapse are often seen. Because the destruction order and condition of the earthquake are not reproducible after the earthquake, the causes of the structure collapse can only be explored speculatively. At present, existing software still cannot simulate the highly nonlinear and discontinuous structural failure and collapse behavior. In this analysis program, a number of highly nonlinear analyzing methods can be freely added, such as multi-support seismic wave input function, simulation of slope sliding on one side of a structure, a collision element simulating collision of members and collision of a falling member with other members, even the situation of falling to the ground, nonlinear connecting element simulating structural support behavior and damage, plastic hinge behavior and fracture of members, and passive earth pressure of soil etc. Compared with the existing finite element dynamic analysis program, this method has the advantages of simplicity, stability, robustness and high efficiency, and can be used to simulate the failure sequence and collapse under extreme external forces.

There are further embodiments provided as follows.

Embodiment 1: A structure analyzing method, characterized in that a computer is configured to execute a process, includes: establishing a spatial-temporal discrete governing model for a discontinuous nonlinear structure based on a finite element analysis, in which the model includes an equivalent nodal secant damping coefficient and an equivalent nodal secant stiffness coefficient at current time step; repeatedly calculating until convergence a secant damping coefficient slope and a secant stiffness coefficient slope based on known parameters, the known equivalent nodal secant damping coefficient and the known equivalent nodal secant stiffness coefficient at previous time step through a computer iteration algorithm; and replacing the equivalent nodal secant damping coefficient and the equivalent nodal secant stiffness coefficient by the converged secant damping coefficient slope and the converged secant stiffness coefficient slope acting as initial values for the next time step.

Embodiment 2: The structure analyzing method as described in Embodiment 1, the process further includes: discretizing the discontinuous nonlinear structure into a plurality of spatial elements and establishing the spatial-temporal discrete governing model for each of the plurality of spatial elements; applying an equivalent Rayleigh damping to the spatial-temporal discrete governing model to form a second spatial-temporal discrete governing model; and applying the known equivalent nodal secant damping coefficient and the known equivalent nodal secant stiffness coefficient at previous time step to form a third spatial-temporal discrete governing model including the equivalent nodal secant damping coefficient and the equivalent nodal secant stiffness coefficient.

Embodiment 3: The structure analyzing method as described in Embodiment 1, the discontinuous nonlinear structure is a discontinuous yielded structure, a discontinuous collapsed structure, a discontinuous cracked structure, a discontinuous damaged structure, a discontinuous fallen structure, a discontinuous failed structure, or a discontinuous separated structure.

Embodiment 4: The structure analyzing method as described in Embodiment 1, the computer iteration algorithm is a quasi-Newton iteration method, or a secant method.

Embodiment 5: A structure analyzing device, characterized in that a hardware processor is configured to implement a process, and the process includes: establishing a spatial-temporal discrete governing model for a discontinuous nonlinear structure based on a finite element analysis, in which the model includes an equivalent nodal secant damping coefficient and an equivalent nodal secant stiffness coefficient at current time step; repeatedly calculating until convergence a secant damping coefficient slope and a secant stiffness coefficient slope based on known parameters, the known equivalent nodal secant damping coefficient and the known equivalent nodal secant stiffness coefficient at previous time step through a computer iteration algorithm; and replacing the equivalent nodal secant damping coefficient and the equivalent nodal secant stiffness coefficient by the converged secant damping coefficient slope and the converged secant stiffness coefficient slope acting as initial values for the next time step.

Embodiment 6: The structure analyzing device as described in Embodiment 5, the process further includes: discretizing the discontinuous nonlinear structure into a plurality of spatial elements and establishing the spatial-temporal discrete governing model for each of the plurality of spatial elements; applying an equivalent Rayleigh damping to the spatial-temporal discrete governing model to form a second spatial-temporal discrete governing model; and applying the known equivalent nodal secant damping coefficient and the known equivalent nodal secant stiffness coefficient at previous time step to form a third spatial-temporal discrete governing model including the equivalent nodal secant damping coefficient and the equivalent nodal secant stiffness coefficient.

Embodiment 7: A non-transitory computer-readable medium storing a program causing a computer to execute a process includes: establishing a spatial-temporal discrete governing model for a discontinuous nonlinear structure based on a finite element analysis, in which the model includes an equivalent nodal secant damping coefficient and an equivalent nodal secant stiffness coefficient at current time step; repeatedly calculating until convergence a secant damping coefficient slope and a secant stiffness coefficient slope based on known parameters, the known equivalent nodal secant damping coefficient and the known equivalent nodal secant stiffness coefficient at previous time step through a computer iteration algorithm; and replacing the equivalent nodal secant damping coefficient and the equivalent nodal secant stiffness coefficient by the converged secant damping coefficient slope and the converged secant stiffness coefficient slope acting as initial values for the next time step.

Embodiment 8: The non-transitory computer-readable medium as described in Embodiment 7, the process further includes: discretizing the discontinuous nonlinear structure into a plurality of spatial elements and establishing the spatial-temporal discrete governing model for each of the plurality of spatial elements; applying an equivalent Rayleigh damping to the spatial-temporal discrete governing model to form a second spatial-temporal discrete governing model; and applying the known equivalent nodal secant damping coefficient and the known equivalent nodal secant stiffness coefficient at previous time step to form a third spatial-temporal discrete governing model including the equivalent nodal secant damping coefficient and the equivalent nodal secant stiffness coefficient.

While the disclosure has been described in terms of what are presently considered to be the most practical and preferred embodiments, it is to be understood that the disclosure need not be limited to the disclosed embodiments. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present disclosure which is defined by the appended claims.

What is claimed is:

1. A structure analyzing method, characterized in that a computer is configured to execute a process, comprising:
establishing a spatial-temporal discrete governing model comprising an equivalent nodal secant damping coefficient and an equivalent nodal secant stiffness coefficient at a current time step for a discontinuous nonlinear structure based on a finite element analysis;
repeatedly calculating until convergence a secant damping coefficient slope and a secant stiffness coefficient slope based on known parameters, the known equivalent nodal secant damping coefficient and the known equivalent nodal secant stiffness coefficient at a previous time step through a computer iteration algorithm performed by the computer; and
replacing the equivalent nodal secant damping coefficient and the equivalent nodal secant stiffness coefficient by the converged secant damping coefficient slope and the converged secant stiffness coefficient slope acting as initial values for a next time step.

2. The structure analyzing method as claimed in claim 1, wherein the process further comprises:
discretizing the discontinuous nonlinear structure into a plurality of spatial elements and establishing the spatial-temporal discrete governing model for each of the plurality of spatial elements;
applying an equivalent Rayleigh damping to the spatial-temporal discrete governing model to form a second spatial-temporal discrete governing model; and
applying the known equivalent nodal secant damping coefficient and the known equivalent nodal secant stiffness coefficient at the previous time step to form a third spatial-temporal discrete governing model comprising the equivalent nodal secant damping coefficient and the equivalent nodal secant stiffness coefficient.

3. The structure analyzing method as claimed in claim 1, wherein the spatial-temporal discrete governing model, the second spatial-temporal discrete governing model, and the third spatial-temporal discrete governing model are defined by equations as follows:
M^{t+Δt}Ü^{(r)}+C^{t+Δt}\dot{U}^{(r)}+^{t+Δt}K_{T}^{(r-1)}ΔU^{(r)}=^{t+Δt}R−^{t+Δt}F_{S}^{(r-1)},
wherein (r) represents the r times iteration, M is the mass matrix, C is the damping matrix, ^{t+Δt}K_{T}^{(r-1)} is the tangent stiffness matrix after the (r−1) times iteration, R is the external force vector, ^{t+Δt}F_{S}^{(r-1)} is the internal force vector for an element node, Ü and \dot{U} are the acceleration vector and the velocity vector for a node respectively, and ΔU^{(r)} is the incremental displacement vector for the r times iteration; and
$${M}_{i}^{t + Δ t} {\ddot{U}}_{i}^{( r )} + {a}_{0} {M}_{i}^{t + Δ t} {\dot{U}}_{i}^{( r )} + {}_{ }^{t + Δ t}{( {\tilde{C}}_{sec} )}{}_{i}^{( r )} Δ {\dot{U}}_{i}^{( r )} + {}_{ }^{t + Δ t}{( {\tilde{K}}_{sec} )}{}_{i}^{( r )} Δ {U}_{i}^{( r )} = {}_{ }^{t + Δ t}{R}{}_{i}^{ } - {}_{ }^{t + Δ t}{( {F}_{kD} )}{}_{i}^{( r - 1 )} - {}_{ }^{t + Δ t}{( {F}_{S} )}{}_{i}^{( r - 1 )} ( i = 1 , … , n )$$
$$and {M}_{i}^{t + Δ t} {\ddot{U}}_{i}^{( r )} + {a}_{0} {M}_{i}^{t + Δ t} {\dot{U}}_{i}^{( r )} + {}_{ }^{t + Δ t}{( {\tilde{C}}_{sec} )}{}_{i}^{( r - 1 )} Δ {\dot{U}}_{i}^{( r )} + {}_{ }^{t + Δ t}{( {\tilde{K}}_{sec} )}{}_{i}^{( r - 1 )} Δ {U}_{i}^{( r )} = {}_{ }^{t + Δ t}{R}{}_{i}^{ } - {}_{ }^{t + Δ t}{( {F}_{kD} )}{}_{i}^{( r - 1 )} - {}_{ }^{t + Δ t}{( {F}_{S} )}{}_{i}^{( r - 1 )} ( i = 1 , … , n ) ,$$
wherein C=a₀M+a₁K_{I} is the equivalent Rayleigh damping, K_{I} is the structure initial stiffness, a₀ and a₁ are constants Δ\dot{U}ᵢ^{(r)} and ΔUᵢ^{(r)} are the incremental velocity vector and the incremental displacement vector for the r times iteration respectively, ^{t+Δt}(F_{kD})ᵢ^{(r-1)} is the element node damping force vector for the previous iteration considering stiffness-proportional damping a₁K_{I}, ^{t+Δt}(F_{kD})ᵢ^{(r-1)} is the element node internal force vector for the previous iteration, ^{t+Δt}(\tilde{C}_{sec})ᵢ^{(r-1)} and ^{t+Δt}(\tilde{K}_{sec})ᵢ^{(r-1)} are the equivalent node secant damping coefficient and the equivalent node secant stiffness coefficient respectively.

4. The structure analyzing method as claimed in claim 1, wherein the equivalent node secant damping coefficient and the equivalent node secant stiffness coefficient are defined by equations as follows:
^{t+Δt}(\tilde{C}_{sec})ᵢ^{(r-1)}Δ\dot{U}ᵢ^{(r-1)}≡Δ^{t+Δt}(F_{kD})ᵢ^{(r-1)} and ^{t+Δt}(\tilde{K}_{sec})ᵢ^{(r-1)}ΔUᵢ^{(r-1)}≡Δ^{t+Δt}(F_{S})ᵢ^{(r-1)},
wherein the Δ^{t+Δt}(F_{kD})ᵢ^{(r-1)} and ^{Δt+Δt}(F_{S})ᵢ^{(r-1)} are the element incremental stiffness-proportional damping force and the element internal force respectively for the previous iteration.

5. The structure analyzing method as claimed in claim 1, wherein the discontinuous nonlinear structure is a discontinuous yielded structure, a discontinuous collapsed structure, a discontinuous cracked structure, a discontinuous damaged structure, a discontinuous fallen structure, a discontinuous failed structure, or a discontinuous separated structure.

6. The structure analyzing method as claimed in claim 1, wherein the computer iteration algorithm is a quasi-Newton iteration method, or a secant method.

7. A structure analyzing device, characterized in that a hardware processor is configured to implement a process, comprising:
establishing a spatial-temporal discrete governing model comprising an equivalent nodal secant damping coefficient and an equivalent nodal secant stiffness coefficient at a current time step for a discontinuous nonlinear structure based on a finite element analysis;
repeatedly calculating until convergence a secant damping coefficient slope and a secant stiffness coefficient slope based on known parameters, the known equivalent nodal secant damping coefficient and the known equivalent nodal secant stiffness coefficient at a previous time step through a computer iteration algorithm performed by the hardware processor; and
replacing the equivalent nodal secant damping coefficient and the equivalent nodal secant stiffness coefficient by the converged secant damping coefficient slope and the converged secant stiffness coefficient slope acting as initial values for a next time step.

8. The structure analyzing device as claimed in claim 7, wherein the process further comprises:
discretizing the discontinuous nonlinear structure into a plurality of spatial elements and establishing the spatial-temporal discrete governing model for each of the plurality of spatial elements;
applying an equivalent Rayleigh damping to the spatial-temporal discrete governing model to form a second spatial-temporal discrete governing model; and
applying the known equivalent nodal secant damping coefficient and the known equivalent nodal secant stiffness coefficient at the previous time step to form a third spatial-temporal discrete governing model comprising the equivalent nodal secant damping coefficient and the equivalent nodal secant stiffness coefficient.

9. A non-transitory computer-readable medium storing a program causing a computer to execute a process, comprising:
establishing a spatial-temporal discrete governing model comprising an equivalent nodal secant damping coefficient and an equivalent nodal secant stiffness coefficient at a current time step for a discontinuous nonlinear structure based on a finite element analysis;
repeatedly calculating until convergence a secant damping coefficient slope and a secant stiffness coefficient slope based on known parameters, the known equivalent nodal secant damping coefficient and the known equivalent nodal secant stiffness coefficient at a previous time step through a computer iteration algorithm performed by the computer; and
replacing the equivalent nodal secant damping coefficient and the equivalent nodal secant stiffness coefficient by the converged secant damping coefficient slope and the converged secant stiffness coefficient slope acting as initial values for a next time step.

10. The non-transitory computer-readable medium as claimed in claim 9, wherein the process further comprises:
discretizing the discontinuous nonlinear structure into a plurality of spatial elements and establishing the spatial-temporal discrete governing model for each of the plurality of spatial elements;
applying an equivalent Rayleigh damping to the spatial-temporal discrete governing model to form a second spatial-temporal discrete governing model; and
applying the known equivalent nodal secant damping coefficient and the known equivalent nodal secant stiffness coefficient at the previous time step to form a third spatial-temporal discrete governing model comprising the equivalent nodal secant damping coefficient and the equivalent nodal secant stiffness coefficient.
